(19) United States
(12) Patent Application Publication
(10) Pub. No.: US 2015/0024809 A1
(43) Pub. Date: Jan. 22, 2015

(54) SLIDING MECHANISM FOR SLIDE-TYPE PORTABLE ELECTRONIC DEVICE

(71) Applicant: Chiun Mai Communication Systems, Inc., New Taipei (TW)

(72) Inventor: YU-CHIA HUANG, New Taipei (TW)

(73) Assignee: Chiun Mai Communication Systems, Inc., New Taipei (TW)

(21) Appl. No.: 14/140,071

(22) Filed: Dec. 24, 2013

(30) Foreign Application Priority Data
Jul. 19, 2013 (TW) 102125900

(51) Int. Cl. H04M 1/02; F16C 33/02

(52) U.S. Cl. CPC H04M 1/0237; F16C 33/02
USPC 455/575.4; 384/8

(57) ABSTRACT

A sliding mechanism for an electronic device comprises a mounting plate, a slide plate, a first magnet, and a second magnet. The slide plate is installed on the mounting plate and is slidable relative to the mounting plate. The first magnet is mounted to the mounting plate. The second magnet is mounted to the slide plate. A magnetic pole of the first magnet faces toward the same magnetic pole of the second magnet.

### BACKGROUND

1. Technical Field

The present disclosure generally relates to sliding mechanisms, and particularly to a portable electronic device with two or more housings using a sliding mechanism to allow one housing to slide relative to another housing.

2. Description of Related Art

Slide-type portable electronic devices have at least two housings, wherein one housing slides over the other to open/close the portable electronic device.

A sliding mechanism is used in the slide-type portable electronic device for opening/closing the electronic device and enabling/disabling functions corresponding to the open and closed states. However, the sliding mechanism is often complex and has a high cost.

Therefore, there is room for improvement within the art.

### BRIEF DESCRIPTION OF THE DRAWINGS

Many aspects of the slide mechanism for slide-type portable electronic device can be better understood with reference to the following drawings. The components in the drawings are not necessarily drawn to scale, the emphasis instead being placed upon clearly illustrating the principles of the slide mechanism for slide-type portable electronic device. Moreover, in the drawings, like reference numerals designate corresponding parts throughout the several views.

FIG. 1 is an exploded, isometric view of an embodiment of a portable electronic device using a sliding mechanism.

FIG. 2 is similar to FIG. 1, but shown from another angle.

FIG. 3 is an assembled view of the portable electronic device.

FIG. 4 is a cross-sectional view of FIG. 3 in a closed state.

FIG. 5 is similar to FIG. 4, but shows the portable electronic device in a partially-open state.

FIG. 6 is similar to FIG. 4, shows the portable electronic device in an open state.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

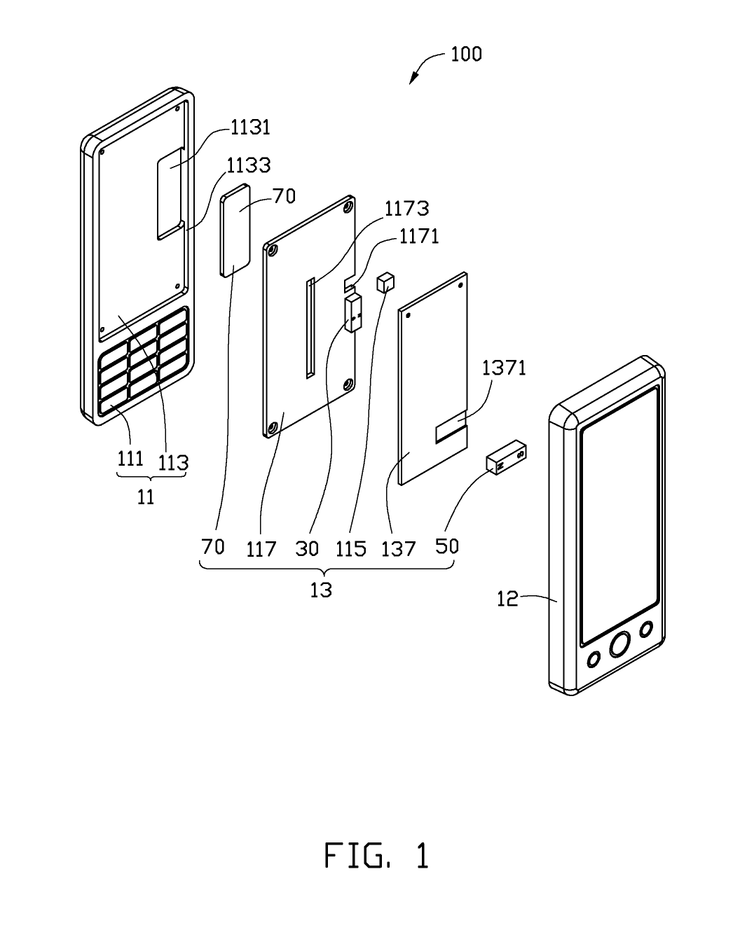

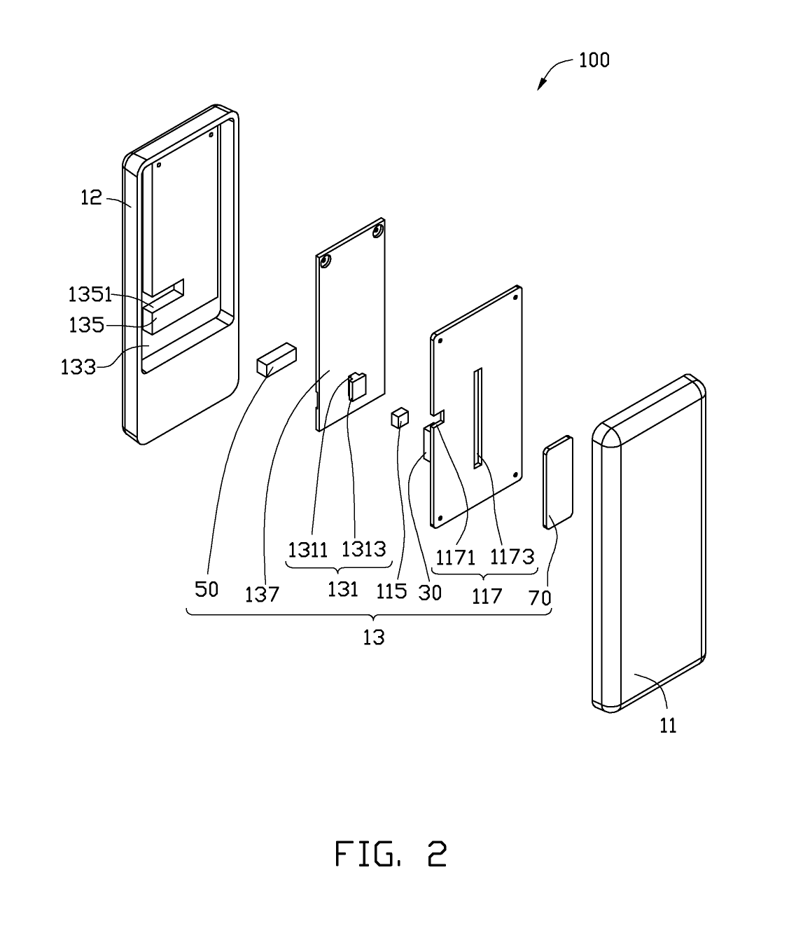

FIGS. 1 and 2 show an exemplary slide mechanism 13 used in a slide-type portable electronic device 100, such as a mobile phone. The portable electronic device 100 comprises a first housing 11 and a second housing 12 engaging with the first housing 11. The slide mechanism 13 is located between the first housing 11 and the second housing 12 to slide the first and second housings 11 and 12 relative to each other. The slide mechanism 13 comprises a mounting plate 117, a magnet detector 115, a slide plate 137, a first magnet 30, a second magnet 50, and a printed circuit board 70.

In the embodiment, the first housing 11 is a base body of the portable electronic device 100. A keypad 111 is located on a first surface of the first housing 11, and a recess 113 is defined adjacent to the keypad 111. The recess 113 is for receiving the mounting plate 117. A receiving groove 1131 is defined in the recess 113 adjacent to a first side of the recess 113 for receiving the printed circuit board 70.

The second housing 12 has a shape corresponding to a shape of the first housing 11. A first surface of the second housing 12 defines an accommodating groove 133, and a projecting plate 135 is formed in the accommodating groove 133. The projecting plate 135 is configured for connecting to the slide plate 137. A substantially rectangular notch 1351 is defined in a side edge of the projecting plate 135.

The mounting plate 117 is assembled in the recess 113 by fasteners and covers the printed circuit board 70. A side edge of the mounting plate 117 defines a notch 1171, and a longitudinal slot 1173 is defined in a substantially middle portion of the mounting plate 117. The notch 1171 receives the magnet detector 115, and the longitudinal slot 1173 is used for guiding a movement of the slide plate 137.

The magnet detector 115 is mounted on the printed circuit board 70. The magnet detector 115 detects a position of the second magnet 50 and transmits a signal to the printed circuit board 70. The printed circuit board 70 further transmits the signal to the portable electronic device 100 for determining an open or closed state of the portable electronic device 100 to allow or disable functions of the keypad 111. In one exemplary embodiment, the magnet detector 115 is a Hall-effect sensor.

The slide plate 137 forms a guiding block 131 on a first surface thereof for being slidably received in the slot 1173. The guiding block 131 is substantially T-shaped and comprises a neck portion 1311 and an extending portion 1313 integrally formed together. The neck portion 1311 has a smaller size than the slot 1173 to allow the neck portion 1311 to extend through the slot 1173. The extending portion 1313 has a larger size than the slot 1173. Thus, the guiding block 131 is latched in the slot 1173. A second surface of the slide plate 137 defines a retaining groove 1371 corresponding to the notch 1351.

The first magnet 30 is mounted to the mounting plate 117 and adjacent to the notch 1171. The first magnet 30 has a south pole S and a north pole N along a polar axis. The longitudinal axis of the first magnet 30 is substantially parallel to the longitudinal axis of slot 1173. The polar axis of the first magnet 30 is substantially perpendicular to the longitudinal axis of the slot 1173.

The second magnet 50 is mounted in the retaining groove 1371 of the slide plate 137. When the slide plate 137 is assembled to the projecting plate 135, one side of the second magnet 50 is received in the notch 1351 of the projecting plate 135. The second magnet 50 comprises a south pole S and a north pole N along a polar axis. Both the longitudinal axis and polar axis of the second magnet 50 is substantially perpendicular to the longitudinal axis of the slot 1173. The polar axis of the second magnet 50 is parallel with the polar axis of the first magnet 30. The south pole S of the second magnet 50 faces toward the south pole S of the first magnet 30.

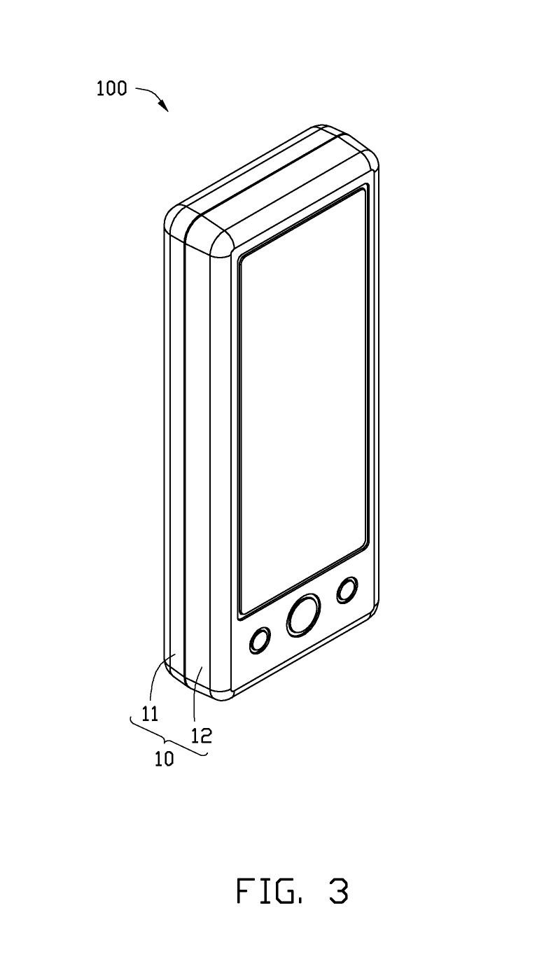

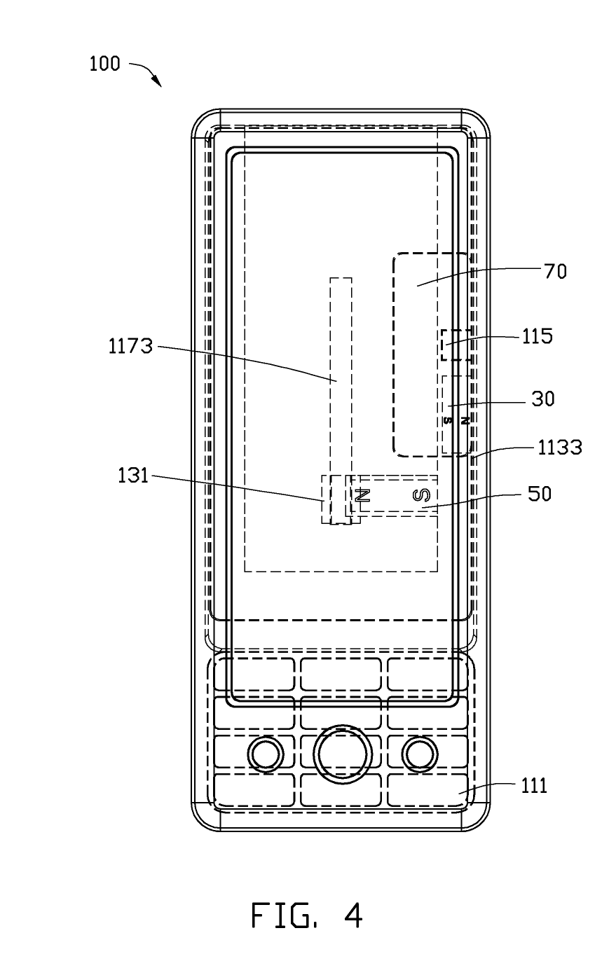

Referring to FIGS. 3 to 4, in assembly, the magnet detector 115 is mounted on the printed circuit board 70. The printed circuit board 70 with the magnet detector 115 is received in receiving groove 1131. The mounting plate 117 is received in the recess 113 for preventing the printed circuit board 70 from separating from the first housing 11. The magnet detector 115 is exposed through the notch 1171 of the mounting plate 117. The first magnet 30 is mounted to the mounting plate 117 and adjacent to the magnet detector 115. The second magnet 50 is received in the retaining groove 1371 of the slide plate 137. The polar axis of the second magnet 50 is parallel with the polar axis of the first magnet 30. The south pole S of the second magnet 50 faces toward the south pole S of the first magnet 30. The slide plate 137 is connected to the projecting plate 135, and the second magnet 50 is received in the notch 1351. The guiding block 131 is slidably received through the slot 1173. Thus, the first housing 11 is slidably connected to the second housing 12.

Referring to FIG. 4, when the electronic device 100 is in a closed state, the second magnet 50 is positioned between the first magnet 30 and the keypad 111. The second magnet 50 is substantially perpendicular to the slot 1173, and the first magnet 30 is substantially parallel to the slot 1173.

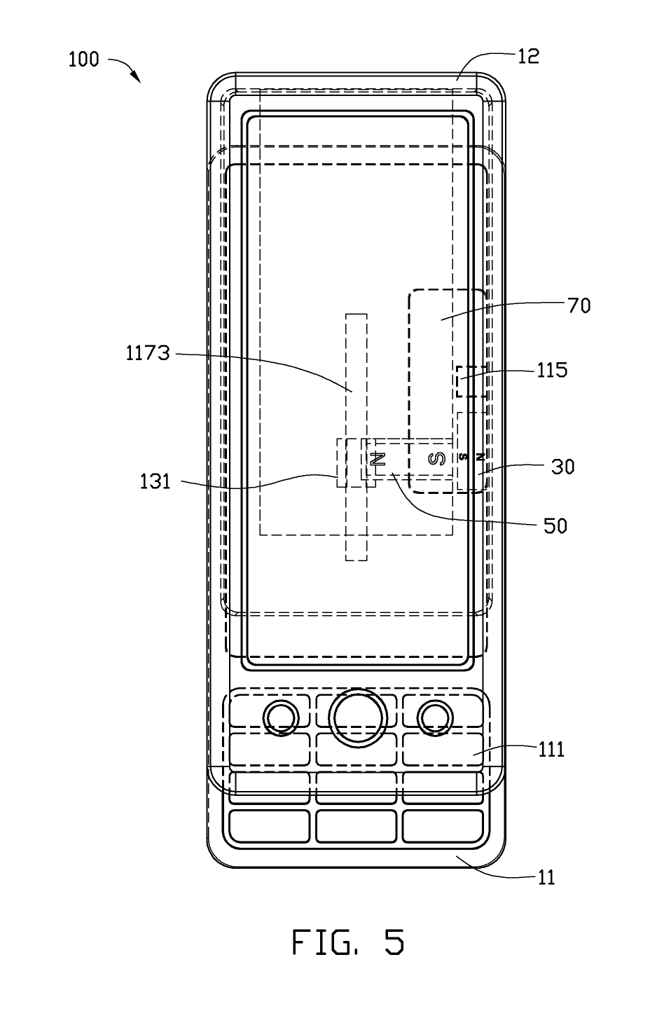

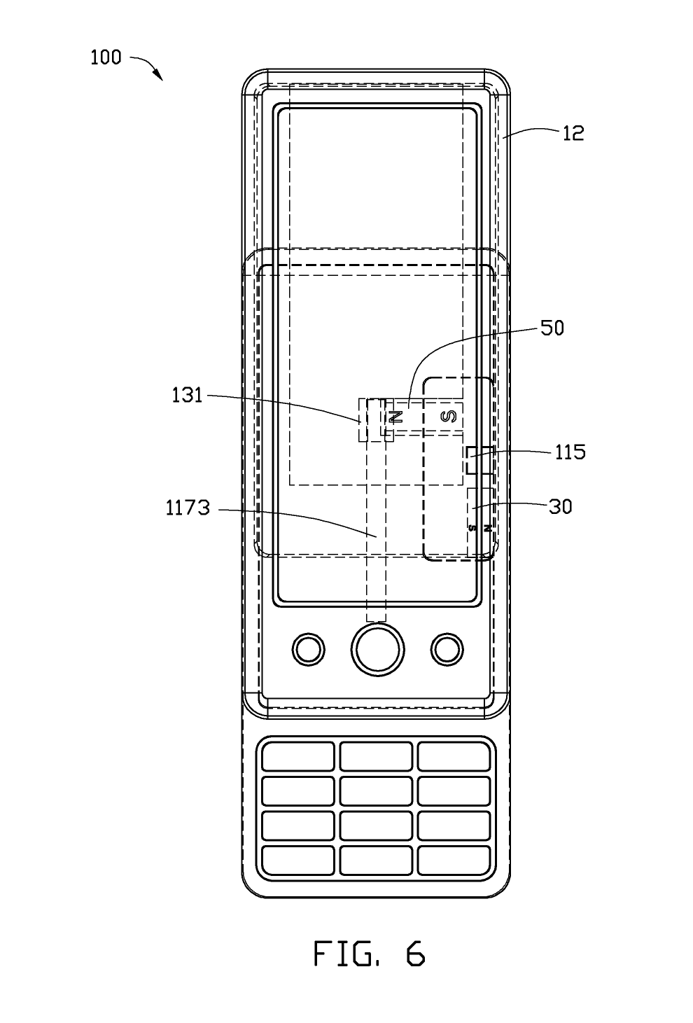

Referring to FIGS. 5 and 6, to position the electronic device 100 in an open position, the second housing 12 is slid to move the slide plate 137 relative to the mounting plate 117 of the first housing 11. The guiding block 131 slides along the slot 1173, and the second magnet 50 is moved toward the first magnet 30. Thus, a repulsive force is produced between the south poles of the second magnet 50 and the first magnet 30. As the polar axis of the second magnet 50 approaches being collinear with the polar axis of the first magnet 30, the magnetic repulsive force between the first magnet 30 and the second magnet 50 is greatest. After the second housing 12 is slid past this position, the slide plate 137 automatically slides to the open position under the repulsive force between the first magnet 30 and the second magnet 50. To slide the slide plate 137 back to the closed position, the slide plate 137 is slid past the position where the second magnet 50 is closest to the first magnet 30, and the repulsive force between the south poles of the first magnet 30 and the second magnet 50 drive the slide plate 137 to close. Thus, the repulsive force between the first magnet 30 and the second magnet 50 assist in opening and closing the slide plate 137 to open and close the electronic device 100 conveniently. During the sliding process, the magnet detector 115 detects the position of the second magnet 50 and transmits a signal to the printed circuit board 70. The printed circuit board 70 further transmits the signal to the portable electronic device 100 for determining whether the portable electronic device 100 is in the open or closed state.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A slide mechanism, comprising:
a mounting plate;
a slide plate installed on the mounting plate and slidable relative to the mounting plate;
a first magnet mounted to the mounting plate; and
a second magnet mounted to the slide plate;
wherein the first magnet is substantially parallel to the slot, a polar axis of the south pole and the north pole of the first magnet is substantially parallel to a polar axis of the south pole and the north pole of the first magnet, and the south pole of the second magnet faces with to the south pole of the first magnet.

2. The slide mechanism as claimed in claim 1, wherein the sliding mechanism comprises a magnet detector and a printed circuit board, the magnet detector is mounted on the printed circuit board for detecting the positions of the second magnet, and transmits a signal to the printed circuit board, and the mounting plate covers the printed circuit board.

3. The slide mechanism as claimed in claim 2, wherein the mounting plate defines a notch and a longitudinal slot, the notch receives the magnet detector, the slide plate has a guiding block being slidably received in the slot for guiding the movement of the slide plate.

4. The slide mechanism as claimed in claim 3, wherein the magnet detector is a hall sensor.

5. The slide mechanism as claimed in claim 4, wherein the guiding block is substantially T-shaped, and comprises a neck portion and an extending portion integrally formed together.

6. The slide mechanism as claimed in claim 5, wherein the neck portion has a smaller size than the slot to allow the neck portion to extend through the slot, the extending portion has a larger size than the slot, and stopped by opposite portions of the slot.

7. A portable electronic device, comprising:
a first housing;
a second housing slidably installed on the first housing;
a slide mechanism, comprising:
a mounting plate;
a slide plate installed on the mounting plate and slidable relative to the mounting plate;
a first magnet mounted to the mounting plate; and
a second magnet mounted to the slide plate;
wherein a polar axis of the south pole and the north pole of the first magnet is substantially parallel to a polar axis of the south pole and the north pole of the first magnet, and the south pole of the second magnet faces with to the south pole of the first magnet.

8. The portable electronic device as claimed in claim 7, wherein the sliding mechanism comprises a magnet detector and a printed circuit board, the magnet detector is mounted on the printed circuit board for detecting the positions of the second magnet, and transmits a signal to the printed circuit board, and the mounting plate covers the printed circuit board.

9. The portable electronic device as claimed in claim 8, wherein the mounting plate defines a notch and a longitudinal slot, the notch receives the magnet detector, the slide plate has a guiding block being slidably received in the slot for guiding the movement of the slide plate.

10. The portable electronic device as claimed in claim 9, wherein the guiding block is substantially T-shaped, and comprises a neck portion and an extending portion integrally formed together.

11. The portable electronic device as claimed in claim 10, wherein the neck portion has a smaller size than the slot to allow the neck portion to extend through the slot, the extending portion has a larger size than the slot, and stopped by opposite portions of the slot.

12. A slide mechanism, comprising:
a mounting plate;
a slide plate installed on the mounting plate and slidable relative to the mounting plate;
a first magnet mounted to the mounting plate; and
a second magnet mounted to the slide plate, a polar axis of the south pole and the north pole of the second magnet being substantially parallel to a polar axis of the south pole and the north pole of the first magnet, and the south pole of the second magnet facing the south pole of the first magnet;
wherein when the slide plate slides along the mounting plate, the second magnet slides relative to the first magnet until the polar axis of the first magnet is collinear with the polar axis of the second magnet, wherein then the slide plate automatically slides to an open position relative to the mounting plate under the repulsive force between the first magnet and the second magnet.
